(19) United States
(12) Patent Application Publication
(10) Pub. No.: US 2006/0031341 A1
(43) Pub. Date: Feb. 9, 2006

(54) Maintaining instant message session status in dynamic operating environments

(76) Inventors: Christopher A. White, Redmond, WA (US); Ivy F. Cunningham, Seattle, WA (US)

Correspondence Address: FSP LLC;Attn: Charles A. Mirho, P.O. Box 890, Vancouver, WA, 98666, US

(21) Appl. No.: 10/941,247

(22) Filed: Sep. 14, 2004

Related U.S. Application Data
(60) Provisional application No. 60/588,018, filed on Jul. 12, 2004.

(51) Int. Cl. G06F 15/16

(52) U.S. Cl. 709/206; 709/227

(57) ABSTRACT

In an instant messaging session, the status of a participant of the instant messaging session is set via a data connection to a network; and changed via a voice connection to the network.

### PRIORITY CLAIM

Priority is hereby claimed to the United States provisional application for patent entitled MAINTAINING INSTANT MESSAGE SESSION STATUS IN DYNAMIC OPERATING ENVIRONMENTS, having application No. 60/588,018, filed on Jul. 11, 2004.

### CROSS-REFERENCE TO RELATED PATENT APPLICATIONS

This application is related to co-pending United States patent applications
______, filed on ______, and claiming priority to U.S. Provisional Patent Application 60/588,307;
______, filed on ______, and claiming priority to U.S. Provisional Patent Application 60/588,110;
______, filed on ______, and claiming priority to U.S. Provisional Patent Application 60/585,965;
______, filed on ______, and claiming priority to U.S. Provisional Patent Application 60/590,185; and
______, filed on ______, and claiming priority to U.S. Provisional Patent Application 60/590,229.

### TECHNICAL FIELD

The present disclosure relates to instant messaging.

### BACKGROUND

Instant messaging is a popular networked application. Typically, one or more participants of an instant messaging session exchange messages by way of a client-server arrangement. The participants operate instant messaging client devices (wireless telephones, personal digital assistants, laptop computers, personal computers, etc.) in communication with an instant messaging server. The status of an instant messaging participant may be indicated as “online” or some similar indication when the participant's instant messaging client maintains a connection to the instant messaging server. The status of an instant messaging participant may be indicated as “offline” or some similar indication when the participant's instant messaging client is not connected with the instant messaging server.

Such a simple status indication may be insufficient when the instant messaging client is a mobile device (wireless telephone, personal digital assistant, laptop computer, and so on). In this and other dynamic environments more detailed and informative instant messaging status information may be desired.

### SUMMARY

The following summary is intended to highlight and introduce some aspects of the disclosed embodiments, but not to limit the scope of the invention. Thereafter, a detailed description of illustrated embodiments is presented, which will permit one skilled in the relevant art to make and use aspects of the invention. One skilled in the relevant art can obtain a full appreciation of aspects of the invention from the subsequent detailed description, read together with the figures, and from the claims (which follow the detailed description).

In an instant messaging session, the status of a participant of the instant messaging (IM) session is set via a data connection to a network, and changed via a voice connection to the network. The presence of the participant in the IM session is maintained after terminating the data connection. The status of the participant in the instant messaging session is set to reflect action of the participant subsequent to terminating the data connection. As a result of a selection to terminate the voice connection, the status of the participant in the instant messaging session is changed to reflect an end of action of the participant subsequent to terminating of data connection. As a result of a selection to reestablish the data connection to the instant messaging session, the status of the participant in the instant messaging session is changed to reflect an end of action of the participant subsequent to terminating of data connection. The status of the participant in the instant messaging session may be changed to reflect the participant's use of the voice connection.

### BRIEF DESCRIPTION OF THE DRAWINGS

The headings provided herein are for convenience only and do not necessarily affect the scope or meaning of the claimed invention.

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1 is a block diagram of an embodiment of an instant messaging system.

FIG. 2 is a block diagram of an embodiment of an instant messaging client.

FIG. 3 is a block diagram of an embodiment of an instant messaging environment.

FIG. 4 is a timing diagram of an embodiment of an instant messaging session as affected by a voice session.

FIG. 5 is an action diagram of an embodiment of an instant messaging session as affected by a voice session.

FIG. 6 is an action diagram of another embodiment of an instant messaging session as affected by a voice session.

FIG. 7 is an action diagram of another embodiment of an instant messaging session as affected by a voice session.

FIG. 8 is a flow chart of an embodiment of a process of setting the status of an instant messaging participant.

FIG. 9 is a flow chart of another embodiment of a process of setting the status of an instant messaging participant.

FIG. 10 is a flow chart of another embodiment of a process of setting the status of an instant messaging participant.

FIG. 11 is a block diagram of an embodiment of an information processing device that may be employed as an IM client.

### DETAILED DESCRIPTION

The invention will now be described with respect to various embodiments. The following description provides specific details for a thorough understanding of, and enabling description for, these embodiments of the invention. However, one skilled in the art will understand that the invention may be practiced without these details. In other instances, well known structures and functions have not been shown or described in detail to avoid unnecessarily obscuring the description of the embodiments of the invention. References to “one embodiment” or “an embodiment” do not necessarily refer to the same embodiment, although they may.

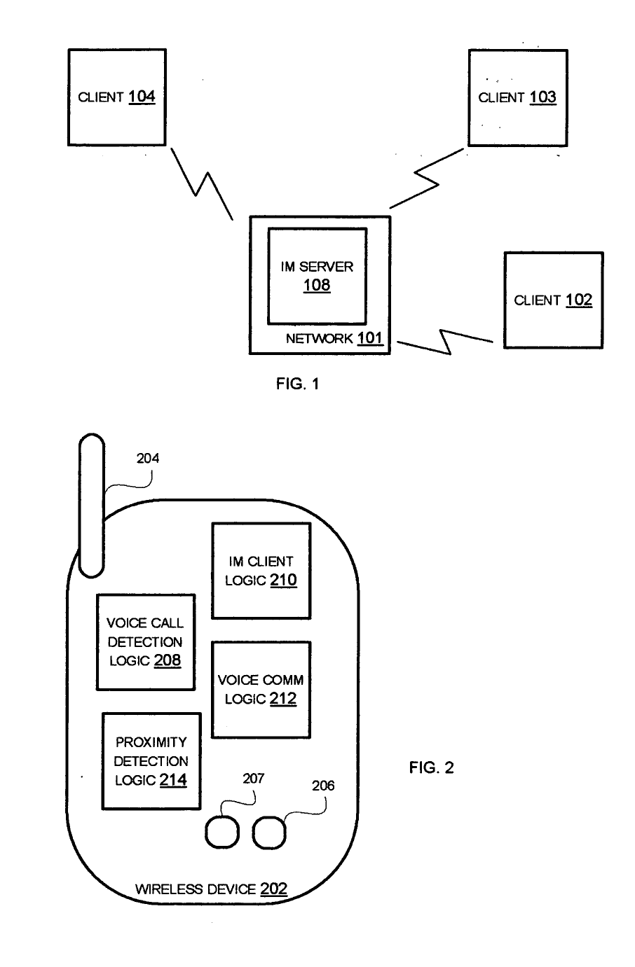

FIG. 1 is a block diagram of an embodiment of an instant messaging system. The instant messaging system comprises instant messaging (IM) clients 102, 103, 104, and a network 101 comprising an instant messaging server 108. The instant messaging clients 102-104 communicate with and/or by way of the instant messaging server 108 to implement an instant messaging session.

The instant messaging server 108 comprises one or more elements within the network 101 that implement the instant messaging service. In one embodiment, the instant messaging server 108 comprises at least one network device that interacts with a plurality of instant messaging clients 102-104 to enable an instant messaging session. The network 101 is a collection of devices to facilitate and/or coordinate the exchange of information. Examples are wired and wireless telephone networks, Internet, satellite and cable networks. The network 101 comprises at least one processor and logic to carry out acts of the processes described herein. A processor is a central processing unit, microcontroller, digital signal processor, or any circuit that can process signals representing information and/or instructions. Logic is circuits operable to affect data processing (e.g. logic gates and other data processing circuits), and/or signals stored in a machine memory that may be applied to affect the operation of data processing circuits (e.g. software).

The IM clients 102-104 are devices, including at least one processor and logic to carry out acts of the processes described herein, operable to enable a user of the device to participate in an instant messaging session. Examples of IM client devices 102-104 are wireless devices such as cell phones, personal digital assistants (PDAs), and laptop computers, as well as personal and business desktop computers. In one embodiment, at least one e.g. one or more—of the IM clients 102-104 is a mobile device, which is a device designed for portability, that may be operated from multiple locations. Mobile devices are often wireless devices, that is, devices that may interact without tangible transmission media (wires, cables, fibers) with and via a network.

The instant messaging service establishes and maintains (i.e. keeps active) instant messaging sessions for instant messaging participants who employ IM client devices to access IM service functionality, such as the capability to take part in message exchanges. In an IM session, status information about at least one IM client participant(s) is maintained by the IM service. The status of a participant is a representation of the participant's state of existence and/or activity.

FIG. 2 is a block diagram of an embodiment of an instant messaging client. The IM client is a wireless device 202 comprising an antenna 204, a voice call activation control 206, a voice call drop control 207, voice call detection logic 208, instant messaging client logic 210, voice communication logic 212, and proximity detection logic 214.

The voice communication logic 212 enables the communication of spoken information between the wireless device 202 and a network. The proximity detection logic 214 detects the proximity of the wireless device 202 to a separate device such as another device capable of wireless communications (for example, a Bluetooth-enabled device). The voice call detection logic 212 detects the presence of an incoming call. The instant messaging client logic 210 enables a user of the wireless device 202 to participate in an instant messaging session.

A control is any mechanism for activating logic within the device. Examples include a key, button, lever, selectable display area, voice-activation mechanism, and touch-sensitive area.

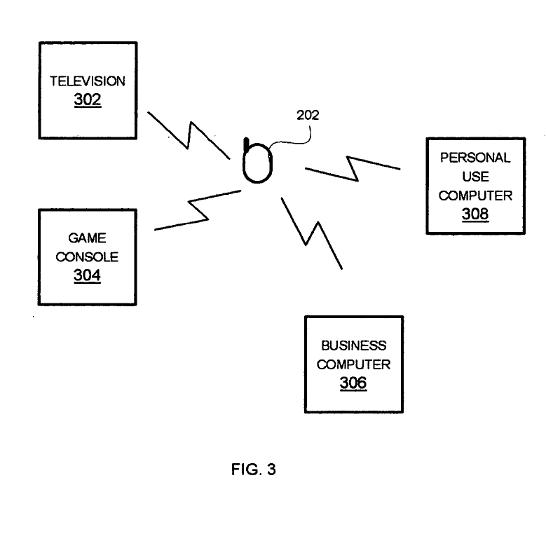

FIG. 3 is a block diagram of an embodiment of an instant messaging environment of the IM client device 202. The instant messaging environment comprises a television 302, a game console 304, a business computer 306, and a personal use computer 308. These separate devices 302, 304, 306, and 308 may be operated independently of the IM client device 202. The IM client device 202 detects in the environment (i.e. identifies the presence of) at least one of the other devices 302, 304, 306, and 308. The status for the IM session participant corresponding to the IM client 202 is set to reflect proximity (i.e. nearness) of the detected device(s) and/or usage state (for example: available or busy or unavailable) as appropriate for at least one of the identified devices 302, 304, 306, and 308.

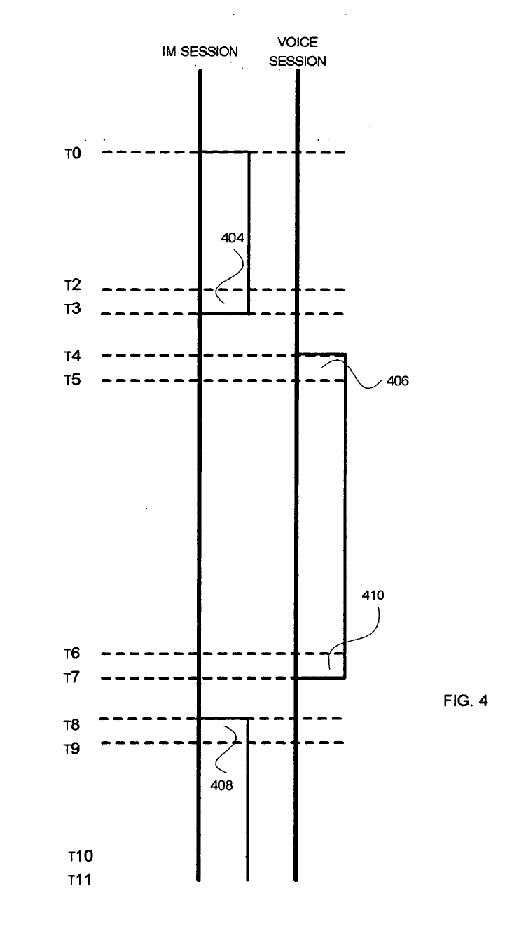

FIG. 4 is a timing diagram of an embodiment of an instant messaging session as affected by a voice session. At TO a person begins using an IM client device to participate in an IM session. At T2 the participant decides to use the IM client device to participate in a voice session, for example by answering an incoming voice call or by placing an outgoing voice call. In this embodiment, the IM client device may not support simultaneous voice and IM sessions. Thus, the IM session may be discontinued at T3, and the voice session is initiated at T4. The voice session may persist until a time T7. At time T8 the IM session is resumed.

The status of the IM participant may be set during various intervals of the IM session and the voice session. At 404, prior to discontinuing the IM session at T3, a status indication may be communicated to the IM server indicating that the participant is participating in a voice session. The indication that the participant is participating in a voice session may also be communicated to the IM server at 406, after the voice session is initiated at T4. One manner of providing such a communication during the voice session is using the Short Messaging Service (SMS), the Enhanced Messaging Service (EMS), and/or the Multimedia Messaging Service (MMS). An indication that the participant has stopped participating in the voice session may be communicated to the IM server at 410, prior to discontinuing the voice session at T7. An indication that the participant has resumed the IM session may be communicated to the IM server at 408.

Thus, in this embodiment, the status of an instant messaging session participant may be set via both a data connection and a voice connection to a network. When the IM client device is a mobile device, the mobile device IM data connection to a network may be terminated, i.e. discontinued or dropped, as a result of the mobile device user selecting (i.e. acting to make a choice) to establish a voice connection to the network. The data connection is a connection over which non-voice information is efficiently exchanged. The voice connection is a connection over which voice information is efficiently exchanged. Thus, a data connection in an instant messaging session may be terminated as a result of a selection for the IM client device to answer/place an incoming/outgoing call. An incoming call is a voice call initiated from a source other than the instant messaging client. An outgoing call is initiated from the instant messaging client. The IM server may maintain a presence, i.e., a representation of existence and/or activity, for the instant messaging session participant after the data connection between the participant's IM client device and the IM server is terminated. The status of the IM session participant may be changed via the voice connection.

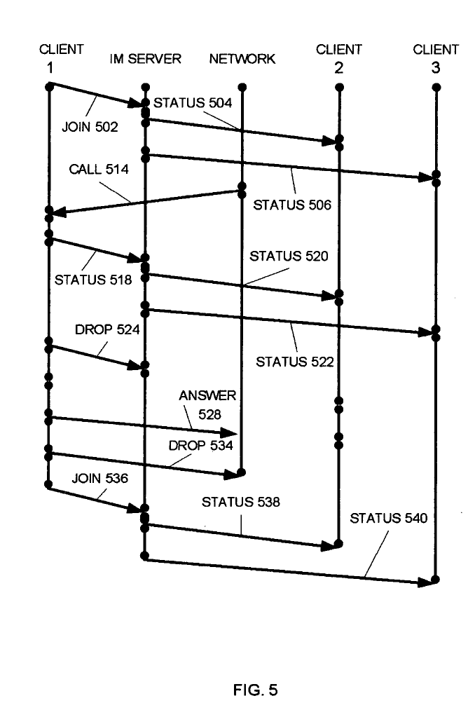

FIG. 5 is an action diagram of an embodiment of an instant messaging session as affected by a voice session.

At 502 IM client 1 joins the IM session. At 504 and 506 the IM server provides a status indication to IM clients 2 and 3 respectively that IM client 1 joined the session.

At 514 the network provides a voice call to client 1. At 516 client 1 selects to answer the voice call, thus establishing a voice connection. At 518 client 1 provides an “on phone” status to the IM server. At 520 and 522 the IM server provides an “on phone” status to clients 2 and 3 respectively. At 524 IM client 1 may communicate to the IM server an indication that it has discontinued participation in the IM session. In some scenarios the IM server may deduce that IM client 1 is no longer participating when the connection between the IM server and client 1 is dropped, or after a period of inactivity in the IM session by client 1.

At 528 client 1 answers a voice call, and the voice session thus created persists until the call is dropped at 534. At 536 client 1 rejoins the IM session (By rejoin it is meant that the client uses a data connection to communicate with the IM server so that it may participate in the services available as part of the IM session). At 538 and 540 the IM server provides an “off phone” status indication to the clients 2 and 3 respectively.

Thus in this embodiment, the status of an IM client participant is set upon client joining the IM session, then modified as other client actions occur. Thus the IM client participant status is changed to reflect each of the following: termination of the data connection; and
subsequent to that termination, participant use of the voice connection; participant termination of the voice connection (and thus the end of action of use of the voice connection); and the selection of the participant to reestablish the data connection to the IM session. The data connection is considered to be “reestablished” because the connection established is with an instant messaging session in which the user was previously a participant. By reestablishing the IM session, the IM client is able to send and/or receive communication associated with a session using a data connection.

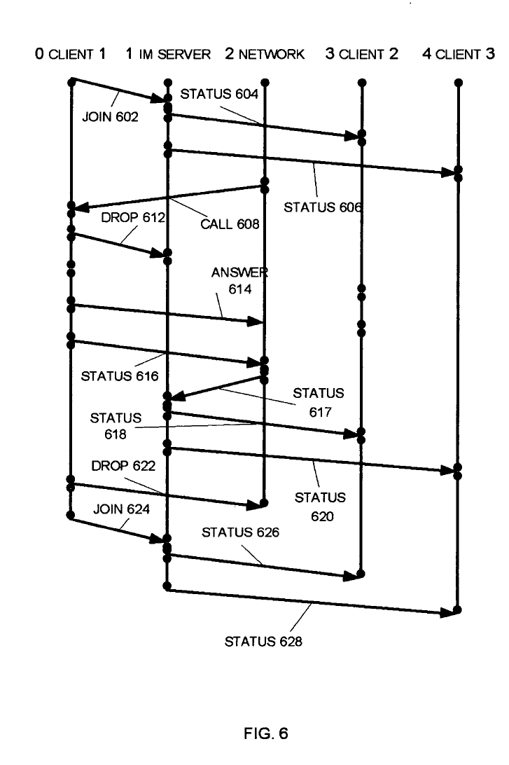

FIG. 6 is an action diagram of another embodiment of an instant messaging session as affected by a voice session. At 602 client 1 joins the IM session. At 604 and 606 the IM server provides to other IM clients 2 and 3, respectively, an indication that the first client joined. At 608 the network provides a call to client 1. At 610 client 1 selects to answer the call, which causes client 1 to drop the connection to the IM server at 612.

At 614 client 1 answers the voice call and at 616 provides an SMS indication of an “on phone” status to the network. At 617 the network provides the “on phone” status indication for client 1 to the IM server. At 618 and 620 the IM server provides the “on phone” status for client I to the other IM clients 2 and 3 respectively. At 622 client 1 discontinues the voice call (e.g. hangs up), and at 624 the client 1 rejoins the IM session. At 626 and 628 the IM server provides a status indication to the other clients 2 and 3 respectively that client 1 is “off the phone”.

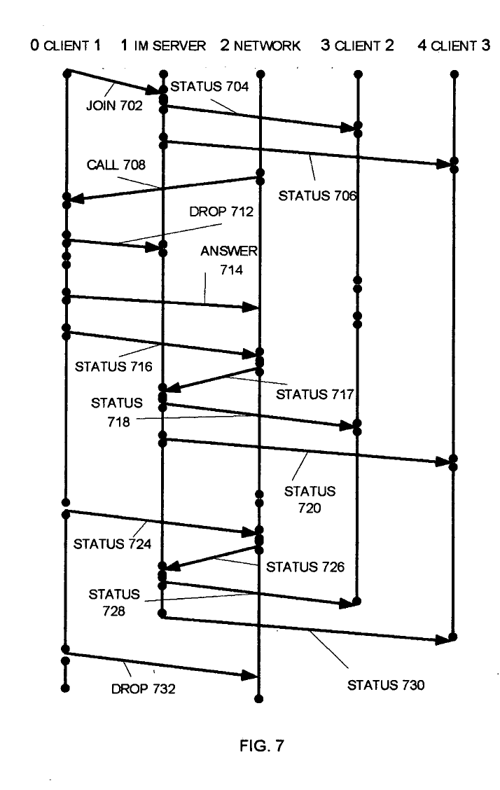

FIG. 7 is an action diagram of another embodiment of an instant messaging session as affected by a voice session. At 702 client 1 joins the IM session. At 704 and 706 the IM server provides to clients 2 and 3, respectively, a status indication that client 1 has joined.

At 708 a voice call is provided to client 1, which client 1 selects to answer at 710, causing the IM session connection to drop at 712. The call is answered at 714 thus starting a voice session. At 716 client 1 provides an SMS (and/or EMS and/or MMS) status indication to the network indicating that the participant is “on the phone”. At 717 the network notifies the IM server of the “on the phone” status of client 1. The IM server provides such notice to the other clients 2 and 3 at 718 and 720 respectively.

At 724, prior to discontinuing the voice session, client 1 provides an SMS (and/or EMS, MMS, or via other voice-band communication mechanism) “off phone” status indication to the network. At 726 the network provides an indication to the IM server that client 1 is “off phone”. At 728 and 730 the IM server provides the “off phone” status indication for the first client to clients 2 and 3. At 732 the first client concludes the voice session (e.g. by hanging up), or by a hang-up by the caller.

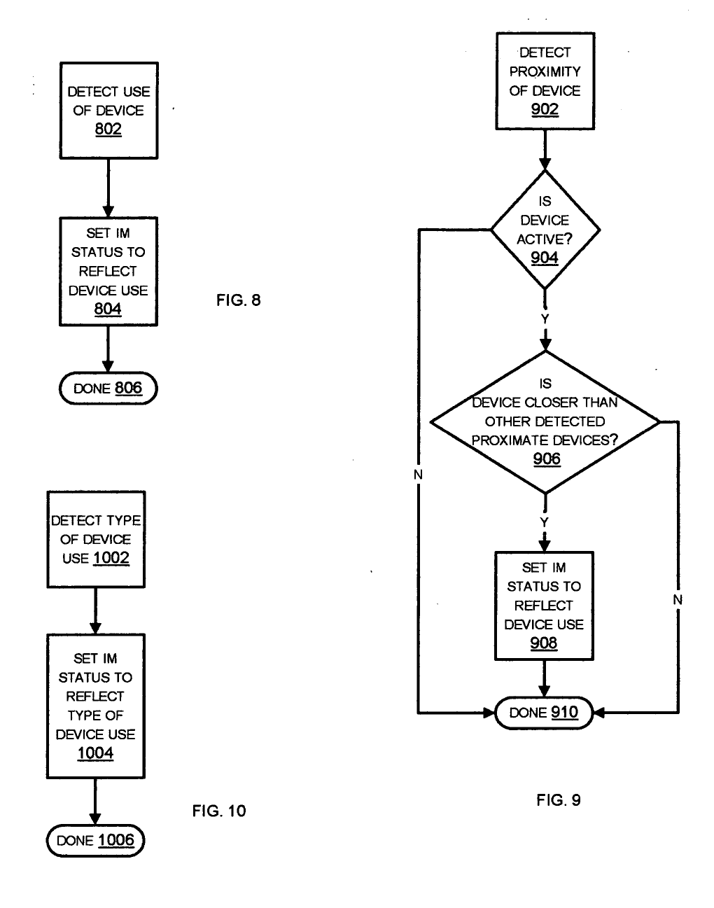

FIG. 8 is a flow chart of an embodiment of a process of setting the status of an instant messaging participant. At 802 use of a device is detected. At 804 the status of an IM participant is set to reflect the device use. At 806 the process concludes.

FIG. 9 is a flow chart of another embodiment of a process of setting the status of an instant messaging participant. At 902 proximity of a device to the wireless IM client is detected. If at 904 the detected device is not active, e.g. activated and in active use, the process concludes at 910. If at 904 the detected device is active, it is determined at 906 whether the device is closer than other detected proximate devices. If at 906 the detected device is not closer than other detected proximate devices, the process concludes at 910. If at 906 it is determined that the detected device is closer than other detected proximate devices, the IM status for the wireless client participant is set at 908 to reflect the participant's use of the device.

The determination of whether a device is active may depend upon several factors, for example, the extent to which controls of the device are manipulated, the extent to which the device performs participant-directed processing, and so on.

FIG. 10 is a flow chart of another embodiment of a process of setting the status of an instant messaging participant. At 1002 a type of device use is detected. At 1004 the status of the instant messaging participant is set to reflect the type of device use. At 1006 the process concludes.

For example, if a television proximate to the IM client device is turned on, and the channels are being changed often, the status of the IM participant may be changed to indicate “channel surfing”.

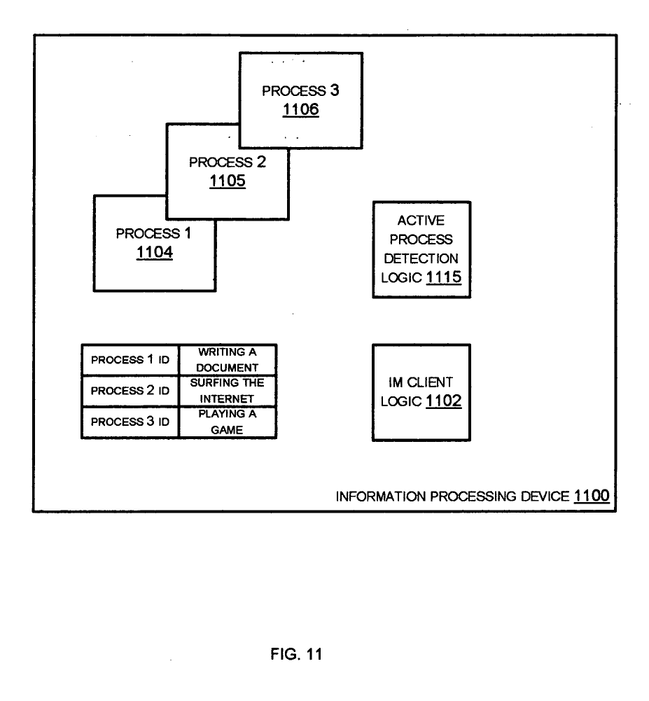

FIG. 11 is a block diagram of an embodiment of an information processing device that may be employed as an IM client. An information processing device 1100 comprises process 1 1104, process 2 1105, and process 3 1106, each process having an associated process id (process 1 id, process 2 id, and process 3 id, respectively). Each process and/or process id is associated with an IM status, such as writing a document, surfing the internet, and playing a game. The information processing device 1100 comprises active process detection logic 1115. The process detection logic may detect which of the processes 1, 2, or 3, if any, is in current use by or is currently of primary use by the IM client user and cause the status of the IM participant in the messaging session to reflect the foreground process. The information processing device 1100 comprises IM client logic 1102.

Determine the process of primary use may involve detecting whether the user interface of the process is in the foreground of the display, and whether the process is the target of keyboard, mouse, or other interface device input signals, among other things.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

What is claimed is:

1. A method comprising:
in an instant messaging session;
setting a status of a participant of the instant messaging session via a data connection to a network; and
changing the status of the participant in the instant messaging session via a voice connection to the network.

2. The method of claim 1 further comprising:
maintaining a presence of the participant in the instant messaging session after terminating the data connection.

3. The method of claim 2 further comprising:
setting the status of the participant in the instant messaging session to reflect action of the participant subsequent to terminating the data connection.

4. The method of claim 3 further comprising:
as a result of a selection to terminate the voice connection, changing the status of the participant in the instant messaging session to reflect an end of action of the participant subsequent to terminating of data connection.

5. The method of claim 3 further comprising:
as a result of a selection to reestablish the data connection to the instant messaging session, changing the status of the participant in the instant messaging session to reflect an end of action of the participant subsequent to terminating of data connection.

6. The method of claim 3 further comprising:
changing the status of the participant in the instant messaging session to reflect the participant's use of the voice connection.

7. A method comprising:
terminating a mobile device instant messaging data connection to a network as a result of a user of the mobile device selecting to establish a voice connection to the network; and
changing a status of the user in an instant messaging session to reflect the user's use of the voice connection.

8. The method of claim 7 further comprising:
changing the status of the user in the instant messaging session via the voice connection.

9. The method of claim 8 further comprising:
changing the status of the participant via the voice connection using at least one of the short message service, the enhanced message service, or the multimedia message service.

10. The method of claim 7 further comprising:
maintaining a presence of the user in the instant messaging session after terminating the data connection.

11. The method of claim 10 further comprising:
setting a status of the user in the instant messaging session to reflect action of the user subsequent to terminating of data connection.

12. The method of claim 11 further comprising:
as a result of a user selection to terminate the voice connection, changing the status of the user in the instant messaging session to reflect an end of the user's use of the voice connection.

13. A mobile device comprising:
at least one processor;
logic that when applied to the at least one processor, results in the mobile device terminating a data connection to an instant messaging session as a result of a selection to answer an incoming call; and
changing a status of the user in the instant messaging session to reflect the user's participation in the call.

14. The mobile device of claim 13 further comprising:
logic that when applied to the at least one processor, results in the mobile device
changing the status of the user in the instant messaging session via the call connection.

15. The mobile device of claim 14 further comprising:
logic that when applied to the at least one processor, results in the mobile device
changing the status of the user via the call connection using at least one of the short message service, the enhanced message service, or the multimedia message service.

16. The mobile device of claim 13 further comprising:
logic that when applied to the at least one processor, results in the mobile device
as a result of a selection to terminating the call connection, changing the status of the user in the instant messaging session to reflect an end of the user's participation in the call.

17. The mobile device of claim 13 further comprising:
logic that when applied to the at least one processor, results in the mobile device
as a result of a selection to reestablish the instant messaging session data connection, changing the status of the user in the instant messaging session to reflect an end of the user's participation in the call.

18. A mobile device comprising:
at least one processor;
logic that when applied to the at least one processor, results in the mobile device
terminating a data connection to an instant messaging session as a result of a selection to make an outgoing call; and
changing a status of a participant in the instant messaging session to reflect the participant's participation in the call.

19. The mobile device of claim 18 further comprising:
logic that when applied to the at least one processor, results in the mobile device
changing the status of the participant in the instant messaging session via a connection of the call.

20. The mobile device of claim 18 further comprising:
logic that when applied to the at least one processor, results in the mobile device changing the status of the participant via the call connection using at least one of the short message service, the enhanced message service, or the multimedia message service.

21. The mobile device of claim 18 further comprising:
logic that when applied to the at least one processor, results in the mobile device
as a result of a selection to terminating the call connection, changing the status of the participant in the instant messaging session to reflect an end of the participant's participation in the call.

22. The mobile device of claim 18 further comprising:
logic that when applied to the at least one processor, results in the mobile device
as a result of a selection to reestablish the instant messaging session data connection, changing the status of the participant in the instant messaging session to reflect an end of the participant's participation in the call.

23. A method comprising:
a mobile device detecting use of a separate device; and
the mobile device setting a status of an instant messaging participant in an instant messaging session to reflect use of the separate device.

24. The method of claim 23 further comprising:
detecting a type of use of the separate device; and
setting the status of the instant messaging participant in the instant messaging session to reflect the type of use of the separate device.

25. The method of claim 23 further comprising:
the mobile device detecting a proximity of the separate device; and
setting the status of the instant messaging participant in the instant messaging session to reflect the proximity of the separate device.

26. The method of claim 25 further comprising:
setting the status of an instant messaging participant in an instant messaging session to reflect a use of a more proximate of a plurality of separate in-use devices.

27. A device comprising:
at least one processor;
logic that when applied to the at least one processor, results in the device
detecting a foreground process; and
setting a status of an instant messaging participant in an instant messaging session to reflect use of the foreground process.
